(19) United States
(12) Patent Application Publication
(10) Pub. No.: US 2011/0147158 A1
(43) Pub. Date: Jun. 23, 2011

(54) PLATE FOR A FRICTIONALLY ACTING DEVICE AND FRICTIONALLY ACTING DEVICE HAVING A PLATE OF SAID TYPE

(75) Inventors: Michael Wilhelm Schaefer, Ketsch (DE); Holger Meub, Zwingenberg (DE); Marc Sagrauske, Frauenwald (DE); Michael Ritschel, Kronau (DE)

(73) Assignee: BorgWarner Inc., Auburn Hills, MI (US)

(21) Appl. No.: 13/058,622

(22) PCT Filed: Aug. 6, 2009
(86) PCT No.: PCT/US2009/052937

§ 371 Date: Feb. 11, 2011

(30) Foreign Application Priority Data
Aug. 18, 2008 (DE) 1020080382825
Dec. 18, 2008 (DE) 1020080636622

(51) Int. Cl. F16D 13/64

(52) U.S. Cl. 192/107 C

(57) ABSTRACT

The present invention relates to a plate for a frictionally acting device, which plate can be rotationally fixedly connected, preferably in a positively locking manner, to a plate carrier. According to the invention, the plate is designed so as to be elastically deformable or resilient in the axial direction. The present invention also relates to a frictionally acting device having a plate of said type.

The present invention relates to a plate for a frictionally acting device, which plate can be rotationally fixedly connected to a plate carrier. The present invention also relates to a frictionally acting device having a plate of said type.

DE 102 55 537 B4 discloses a frictionally acting device in the form of a multiplate clutch. The known multiplate clutch comprises a first plate set, which is rotationally fixedly connected to a first plate carrier, and a second plate set, which is rotationally fixedly connected to a second plate carrier and whose plates can be placed directly in frictional engagement with the plates of the first plate set in the axial direction. The plates of the two plate sets are formed in the manner of annular disks and are of planar or flat design. An undulating disk is arranged in the axial direction between two adjacent plates of the same plate set, which undulating disk is likewise of substantially annular-disk-shaped design, but has no rotationally fixed connection to any of said plate carriers. The aim of the undulating disks is to hold the plates of the plate sets in a uniform distribution, with a further aim of the undulating disks being to compensate any tolerances or axial run-out which may be present. Furthermore, it is sought to obtain improved damping behavior with a smoother rise in clutch torque when the plate pack composed of the first and second plate sets is acted on with hydraulic pressure.

The above-described prior art has the disadvantage, inter alia, that the axial structural length and also the weight of the plate pack and therefore of the entire multiplate clutch is increased.

It is therefore an object of the present invention to create a plate for a frictionally acting device, by means of which plate it is possible to obtain a high degree of torque uniformity, jerk-free starting and shifting, and compensation of any tolerances or axial run-out which may be present, without significantly increasing the axial structural length and the weight of the frictionally acting device. The invention is also based on the object of creating a frictionally acting device having at least one plate of said type.

Said object is achieved by means of the features specified in patent claims 1 and 11. The subclaims relate to advantageous embodiments of the invention.

The plate according to the invention is designed for use within a frictionally acting device such as for example a multiplate clutch or brake, with the frictionally acting device preferably being a starting clutch. The plate may for example be a steel plate or a friction lining plate. A steel plate is to be understood here, and also below, to mean a plate which is composed of steel and which duly has one or two friction surfaces, but without any additional friction lining, such as for example a paper friction lining, being arranged on said steel plate to form said friction surfaces. In contrast, a friction lining plate is to be understood here, and also below, to mean a plate which has a friction lining carrier on which is also arranged at least one friction lining, such as for example a paper friction lining, to form the friction surface of the friction lining plate. The plate according to the invention may be rotationally fixedly connected to a plate carrier of the frictionally acting device. This is to be understood in particular to mean that the plate has provided on it corresponding means which permit a rotationally fixed connection to a plate carrier. Such means may for example be a toothing which can engage into the toothing of the plate carrier in order to generate the rotationally fixed connection. According to the invention, the plate is designed so as to be elastically deformable or resilient in the axial direction.

On account of the elastic deformability of the plate or the resilience of said plate in the axial direction, it is possible to obtain a particularly high degree of torque uniformity of the frictionally acting device. An additional component in the form of an undulating disk, which is described in DE 102 55 537 B4 and which is not, or cannot be, rotationally fixedly connected to the plate carrier, is not required. In this way, it is possible for the axial structural length of the plate pack and therefore of the entire frictionally acting device to be reduced by means of the plate according to the invention. The number of parts or variety of parts is also reduced on account of the fact that no additional component in the form of an undulating disk is required, as a result of which the assembly of the frictionally acting device is simplified. The plate which is elastically deformable, or of resilient design, in the axial direction also has the advantage that imbalances or noises during operation of the frictionally acting devices are suppressed, especially since the plate according to the invention—as already mentioned—can be rotationally fixedly connected to the plate carrier, in contrast to the known undulating disk.

In a preferred embodiment of the plate according to the invention, the plate can be rotationally fixedly connected in a positively locking manner to a plate carrier. As already mentioned above, the plate may have, for this purpose, a toothing or a projection which corresponds to a corresponding toothing or a corresponding recess on the plate carrier in order to generate a positively locking rotationally driving connection between the plate and the plate carrier. With regard to the advantages of a plate which is designed to be elastically deformable or resilient in the axial direction and which can be rotationally fixedly connected in a positively locking manner to the plate carrier, reference is made to the advantages described above.

To obtain elastic deformability or resilience of the plate in the axial direction, which entails only a small loading of the plate material which is used, in a further preferred embodiment of the plate according to the invention, the plate is also designed to be elastically deformable or resilient in the circumferential direction and/or in the radial direction. In this way, the plate can be elastically or resiliently expanded for example in the circumferential direction and/or in the radial direction as a result of an axial compression, such that a high fatigue strength of the plate can be obtained, which is particularly high in the case of elastic deformability or resilience in the radial direction.

In one advantageous embodiment of the plate according to the invention, the plate is of annular-disk-shaped design. In order to obtain a rotationally fixed connection to the plate carrier, the annular-disk-shaped plate preferably has an outer or inner toothing. In the case of an outer toothing, the plate would accordingly form an outer plate, while in the case of an inner toothing, the plate would be an inner plate. Regardless of whether the plate is an inner or outer plate, the plate may be formed either as a steel plate or as a friction lining plate, as already explained above. If the annular-disk-shaped plate is provided with an outer or inner toothing, then the plate carrier should have a corresponding counterpart toothing into which the outer or inner toothing of the annular-disk-shaped plate can engage in a positively locking manner in order to generate the rotationally fixed connection.

To be able to provide the elastic deformability or resilience of the plate in the axial direction in a particularly simple manner, in one particularly preferred embodiment of the plate according to the invention, the plate has an undulating or stepped profile in the circumferential direction and/or in the radial direction. The undulating profile in the circumferential direction may thus for example correspond to the profile in the circumferential direction of the undulating disk known from DE 102 55 537 B4, but the above-mentioned advantages for the frictionally acting device are obtained as a result of the undulating design of the plate itself. The plate with an undulating or stepped profile in the radial direction has proven to be particularly durable in this context, especially since elastic deformability or resilience of the plate in the radial direction is likewise provided in this way. If a sufficient clearance is provided within the frictionally acting device in the radial direction, then the loading of the plate material which is used is particularly low. In the present embodiment, both undulating and also stepped profiles of the plate in the circumferential direction and/or in the radial direction have proven to be advantageous, with a stepped profile of the plate also having the advantage that the points or areas of pressure contact of the plate against a counterpart plate are more precisely defined. In this respect, the plate having a stepped profile can be adapted very precisely to the occurring axial forces in order to prevent excessively high pressures in individual regions of the plate.

According to a further preferred embodiment of the plate according to the invention, the undulating or stepped profile of the plate is generated by means of targeted shaping, with the undulating or stepped profile preferably being of regular design. In this embodiment, the undulating or stepped profile is therefore generated in a targeted fashion in order to obtain the desired high degree of elastic deformability or resilience, which is not possible to this extent, as a result of possible deviations or tolerances, in the production of conventional planar or flat plates.

In a further preferred embodiment of the plate according to the invention with an undulating profile in the circumferential direction and/or in the radial direction, the plate has a sinusoidal profile in the circumferential direction and/or in the radial direction, as a result of which the torque uniformity is further increased and a compensation of tolerances and axial run-out is further improved.

In the case of a plate which comprises means for positively locking rotationally fixed connection to a plate carrier, such as for example an inner or outer toothing, it is desirable for said means or toothings not to have an undulating or stepped profile, in order to reduce the production expenditure for the plate and to prevent jamming of the plate with the plate carrier in the axial direction. In a further advantageous embodiment of the plate according to the invention, the plate is therefore designed to be elastically deformable or resilient in the axial direction only in partial regions. The plate thus preferably has at least one axially projecting spring tongue or bridge which can be pressed against a counterpart plate and which is designed so as to be elastically deformable or resilient in the axial direction. Here, spring tongues or bridges of said type can be generated for example by partially punching such spring tongues or bridges out of the plate, with the spring tongues or bridges simultaneously or subsequently being pressed or pulled out in the axial direction. Regardless of the respective type of production, it has proven to be advantageous if preferably at least three axially projecting spring tongues or bridges are provided which project in one of the two opposite axial directions. Tilting of the plate with respect to the rotational axis of the frictionally acting device is hereby prevented.

In a further advantageous embodiment of the plate according to the invention, the plate is of conical design in the axial direction, with the plate preferably being formed in the manner of a plate spring. In this embodiment, too, a high degree of torque uniformity and a compensation of any axial run-out or tolerances which may be present are likewise obtained, although it should be noted that the torque uniformity is only at its greatest if the conical design of the plate is combined with one of the preceding embodiments of the plate, in particular with a profile of the plate which is undulating or stepped in the circumferential direction and/or in the radial direction.

As already mentioned above, the plate according to the invention may fundamentally be a steel plate or a friction lining plate. However, to simplify the production of the plate according to the invention, in a further particularly preferred embodiment of the plate according to the invention, the plate is formed as a steel plate. With regard to the meaning of the term “steel plate”, reference is made to the definition of a steel plate as given above. In the case of the design of the plate according to the invention as a steel plate, it is therefore possible to dispense with a retroactive attachment of a friction lining, which can lead to problems during production in the case of a, for example, undulating or stepped profile of the plate. The prior attachment of the friction linings is also not necessary, especially since this could lead to damage to the friction lining during a later deformation of the plate, for example for the purpose of providing an undulating or stepped profile of said plate.

As already mentioned with reference to the above-described embodiment of the plate according to the invention as a steel plate, the production of the plate according to the invention, which is formed as a steel plate, is simpler than in the case of a plate which is formed as a friction lining plate. Said problems can however be overcome by means of suitable adaptation of the production method, such that in a further preferred embodiment of the invention, the plate is formed as a friction lining plate which has a friction lining carrier and at least one friction lining which is arranged on the friction lining carrier and which forms the friction surface of the friction lining plate. In this embodiment, it is preferable if the friction lining carrier or the friction lining is formed so as to be elastically deformable or resilient in the axial direction, in the circumferential direction and/or in the radial direction, with it being particularly preferable if the friction lining carrier or the friction lining has an undulating, preferably sinusoidal, or stepped profile in the circumferential direction and/or in the radial direction, and/or is of conical design in the axial direction. With regard to the advantages of the abovementioned possible design variants of said embodiment, reference is made to the advantages of the above-described embodiments of the invention, which advantages apply correspondingly. It is however mentioned that it is simplest to produce those design variants of the plate, which is formed as a friction lining plate, in which the friction lining but not the friction lining carrier is provided with the said modifications. It is thus possible, for example, for the friction lining to be modified in the desired way, for example in order to obtain the undulating or stepped profile of said friction lining, as said friction lining is adhesively bonded and pressed onto the friction lining carrier. Furthermore, the friction lining may also be composed of friction lining segments which have different thicknesses from one another and which can be attached independently of one another to the friction lining carrier, for example in order to obtain the desired stepped profile of the entire friction lining. In said design variants which provide a modification of the friction lining, the friction lining carrier itself may maintain its substantially planar or flat original shape in order to obtain a corresponding profile, although it should be noted that the friction lining carrier may also alternatively or additionally be modified in the above-described way.

According to a further particularly advantageous embodiment of the plate according to the invention, the plate is formed as a steel plate and has at least two or three, preferably four to six, particularly preferably more than six wave or step peaks. Of preference, therefore, are at least two wave or step peaks in the case of a steel plate with an undulating or stepped profile in the radial direction, and at least three wave or step peaks in the case of a steel plate with an undulating or stepped profile in the circumferential direction. The advantage is that tilting of the steel plate about the rotational axis of the frictionally acting device can be reliably prevented by means of the above-specified minimum numbers of two or three wave or step peaks. Since a steel plate has more space in the circumferential direction for the formation of the wave or step peaks than is the case in the radial direction, it is also preferable in the case of steel plates with an undulating or stepped profile in the circumferential direction to provide four to six wave or step peaks. From the knowledge that the axial structural length of the individual steel plates can be reduced by increasing the number of wave or step peaks, it is particularly preferable if the steel plate with an undulating or stepped profile in the circumferential direction has more than six wave or step peaks. Regardless of the respective design variant of said embodiment of the plate according to the invention, it is also preferable if the plate has a corresponding number of wave or step peaks to the number of wave or step troughs.

In a further advantageous embodiment of the plate according to the invention, the plate is formed as a friction lining plate and has at least two or six, preferably eight to twelve, particularly preferably more than twelve wave or step peaks. Here, in the case of a friction lining plate with an undulating or stepped profile in the circumferential direction, at least the stated six wave or step peaks are preferable in order to firstly prevent tilting of the friction lining plate about the rotational axis of the frictionally acting device and secondly to ensure the required stiffness of the friction lining plate, which is generally lower than in the case of a steel plate. The at least two wave or step peaks are again preferable, in the case of a friction lining plate with an undulating or stepped profile in the radial direction, to prevent tilting of the friction lining plate about the rotational axis of the frictionally acting device. The required stiffness of the friction lining plate is ensured here already by the undulating or stepped profile in the radial direction. In both cases, a preferred range has proven to be a number from eight to twelve wave or step peaks, since this ensures firstly the required stability against a tilting movement about the rotational axis of the frictionally acting device, and secondly a small structural length of the friction lining plate. It is however particularly preferable for the friction lining plate to have more than twelve wave or step peaks in order to reduce the axial structural length of the individual friction lining plate and therefore of the entire plate pack of the frictionally acting device, especially since, the greater the number of wave or step peaks, the smaller the height of the wave or step peaks can be. In said embodiment, too, a corresponding number of wave or step troughs to the number of wave or step peaks is provided regardless of the respective design variant.

According to a further advantageous embodiment of the plate according to the invention, the undulating or stepped profile of the plate is produced by means of cold or hot working. The undulating or stepped profile may thus be produced for example by means of flattening and setting of the plate during its production. Here, cold working has proven to be the better solution, especially since it is thereby possible to obtain a more predictable final shape, such that more precise adaptation to the loadings which occur within the frictionally acting device is possible. From a production aspect, it has also proven to be advantageous if the plate is punched out of a sheet-metal part, with the cold working taking place as the plate is punched out.

The frictionally acting device according to the invention, which is preferably a multiplate clutch or a multiple plate clutch, particularly preferably a hydraulically actuable multiplate clutch or multiple plate clutch, has a first plate set, which is rotationally fixedly connected to a first plate carrier, and a second plate set which is rotationally fixedly connected to a second plate carrier. Here, the term “plate set” refers to a combination or a set of at least two plates. The plates of the second plate set can be placed, preferably directly, in frictional engagement with the plates of the first plate set in the axial direction. The plates of the first plate set may thus be arranged alternately in series with the plates of the second plate set in the axial direction. According to the invention, at least one plate of the first or second plate set is one of the above-described plates according to the invention. As already explained with reference to the plate according to the invention, the frictionally acting device according to the invention has a particularly high degree of torque uniformity, a low weight and a small axial structural length, with the two latter advantages being attributable to the fact that use is made not of a separate undulating disk but rather instead of the plate which is formed so as to be elastically deformable or resilient in the axial direction. The advantages of the frictionally acting device according to the invention come to bear in particular if said frictionally acting device is a hydraulically actuable multiplate clutch or multiple plate clutch, especially since, in this way, even the slightest fluctuations or oscillations in the hydraulic supply can be compensated in order to obtain a high degree of torque uniformity and for example a smooth rise in torque during starting.

The best result with regard to torque uniformity has been obtained with a preferred embodiment of the frictionally acting device according to the invention in which the first or second plate set has a number of n plates, with at least a number of n−2 plates of said plate set being designed as plates according to the invention. It is thus possible, for example, for two conventional plates to be provided within said plate set, which conventional plates then specifically do not correspond to the plate according to the invention, and are preferably of flat or planar design and are neither resilient nor elastically deformable in the axial direction. In this context, it has proven to be advantageous if the two conventional plates form the end plates of said plate set, wherein at least one of the conventional plates preferably is or can be supported in the axial direction on an actuating element or stop element for said plate set. The actuating element may for example be a hydraulically driven actuating piston, while the stop element may for example be formed by a stop on one of the plate carriers. In the latter design variant of said embodiment, it has been found that an improved absorption of the axial forces which act on the plate pack is possible without reducing the torque uniformity of the frictionally acting device.

In a further preferred embodiment of the frictionally acting device according to the invention, at least two, preferably all of the plates, which are adjacent to one another in the axial direction, of the first or second plate set are connected, in a rotationally fixed manner relative to one another, to the corresponding plate carrier in such a way that the wave or step peaks, preferably all the wave or step peaks, of the one plate are arranged substantially in alignment in the axial direction with the wave or step peaks of the adjacent plate. In this context, the plates which are adjacent to one another are to be understood to mean those plates of the same plate set which are arranged in direct succession in one of the axial directions, wherein it is self-evidently possible for a plate of the other plate set to be arranged in between. A substantially aligned arrangement is to be understood here preferably to mean that more than 50% of the width of the one wave or step peak in the circumferential direction is arranged in alignment in the axial direction with the other wave or step peak, with said value particularly preferably being more than 75% in order to obtain a high degree of torque uniformity. In the targeted arrangement of the adjacent plates of the same plate set, it has surprisingly been found that a significantly higher degree of torque uniformity and an even better compensation of any tolerances or axial run-out which may be present can be obtained than is the case with any arbitrary relative arrangement of the wave or step peaks.

On the basis of the above-described embodiment of the frictionally acting device according to the invention, it is also the case in a further advantageous embodiment of the frictionally acting device according to the invention that the wave or step troughs, preferably all of the wave or step troughs, of the one plate are arranged substantially in alignment in the axial direction with the wave or step troughs of the adjacent plate. Here, too, a substantially aligned arrangement is to be understood preferably to mean that more than 50% of the width of the one wave or step trough in the circumferential direction is arranged in alignment in the axial direction with the other wave or step trough, with said value again preferably being more than 75% in order to obtain a high degree of torque uniformity. With regard to the advantages of this embodiment, reference is made to the advantages of the embodiment described above, which apply correspondingly.

In a further particularly preferred embodiment of the frictionally acting device according to the invention, at least two, preferably all, of the plates, which are adjacent to one another in the axial direction, of the first or second plate set are connected, in a rotationally fixed manner relative to one another, to the corresponding plate carrier in such a way that the central points, preferably all of the central points, of the wave or step peaks of the one plate are arranged substantially in alignment in the axial direction with the central points of the wave or step peaks of the adjacent plate. Central points which are arranged substantially in alignment in the axial direction is to be understood to mean that the central point of the wave or step peak of one plate with respect to the circumferential direction is arranged as close as possible to the central point of the wave or step peak of the adjacent plate of the same plate set. Ideally, said central points lie on a common straight line which extends parallel to the axial directions. Deviations from the ideal case may for example result from the toothings on the plates and from the counterpart toothing, which is assigned to said toothings, on the plate carrier, which toothings and counterpart toothings do not permit an axially aligned arrangement of the central points of the wave or step peaks in the axial direction. Here, a central point of the wave or step peak need not imperatively mean that point which is arranged in the middle with respect to the width of the wave or step peak in the circumferential direction; it is in fact preferable if a central point of the wave or step peak is alternatively or additionally understood to mean the highest point, or the wave or step tip, of the wave or step peak. With all of the above-stated variants of this embodiment, it is possible to obtain a particularly high degree of torque uniformity, and a more reliable compensation of axial run-out and tolerances.

On the basis of the above-described embodiment of the frictionally acting device according to the invention, it is also the case that the central points, preferably all of the central points, of the wave or step troughs of the one plate are arranged substantially in alignment in the axial direction with the central points of the wave or step troughs of the adjacent plate. Here, too, a substantially aligned arrangement of the central points is to be understood to mean that the central point of the wave or step trough of the one plate with respect to the circumferential direction is arranged as close as possible to the central point of the wave or step trough of the adjacent plate of the same plate set. Here, too, said central points ideally lie on a common straight line which extends parallel to the axial directions. Here, a central point of the wave or step trough need not imperatively mean that point which is arranged in the middle with respect to the width of the wave or step trough in the circumferential direction; it is in fact preferable if a central point of the wave or step trough is alternatively or additionally understood to mean the lowest point of the wave or step trough. With regard to the advantages of this embodiment, reference is made to the advantages of the embodiment described above, which apply correspondingly, wherein a further improvement in torque uniformity can be obtained by means of the combination.

As already mentioned above, the frictionally acting device according to the invention yields its advantages in particular if used as a starting clutch. For this reason, in a further particularly preferred embodiment of the invention, the frictionally acting device, which is designed as a multiple clutch, has at least one first clutch, which functions as a starting clutch, and a second clutch, with at least one plate of the first clutch or starting clutch being a plate according to the invention. The first clutch and the second clutch may be in each case a selectively actuable plate pack which is composed of the above-mentioned first and second plate sets. The first clutch, which functions as a starting clutch, therefore permits jerk-free starting when using the multiple plate clutch according to the invention.

The invention is explained in more detail below on the basis of exemplary embodiments and with reference to the appended drawings, in which:

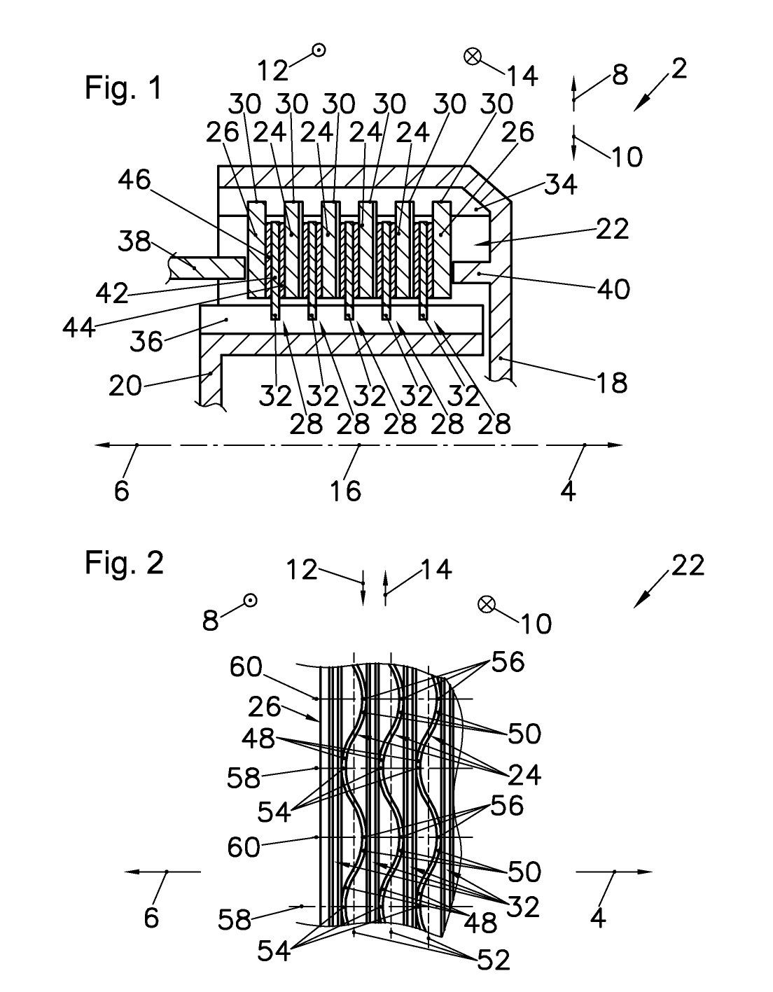

FIG. 1 shows a partial side view of an embodiment of the frictionally acting device according to the invention in a sectioned illustration,

FIG. 2 shows a partial side view of the plate pack from FIG. 1 in a first embodiment,

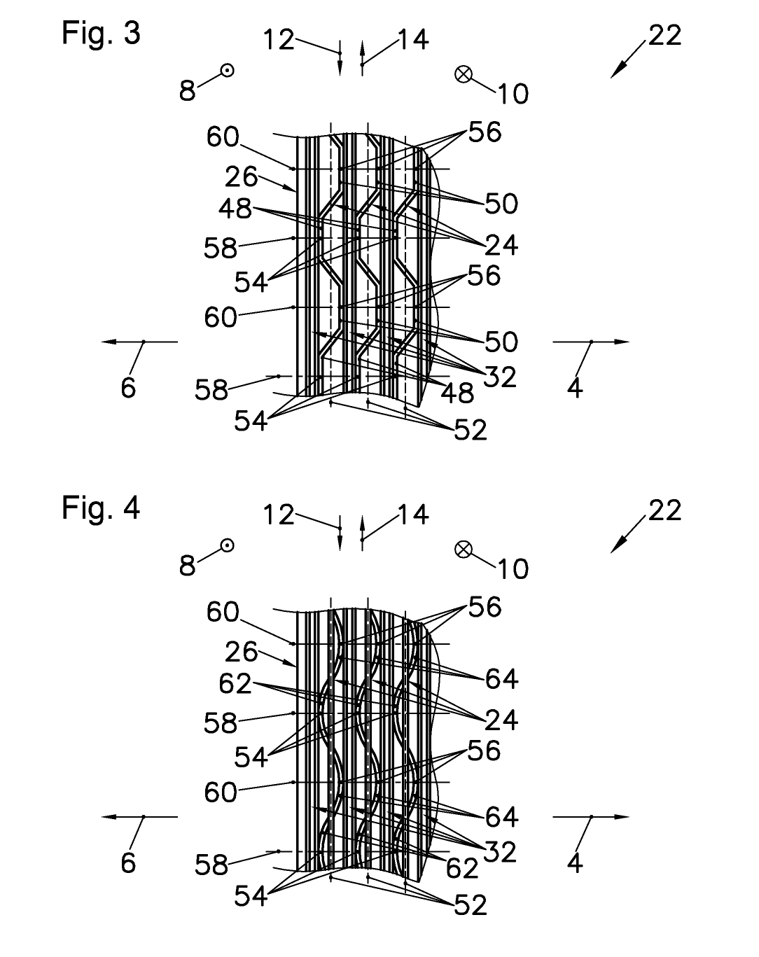

FIG. 3 shows a partial side view of the plate pack from FIG. 1 in a second embodiment,

FIG. 4 shows a partial side view of the plate pack from FIG. 1 in a third embodiment,

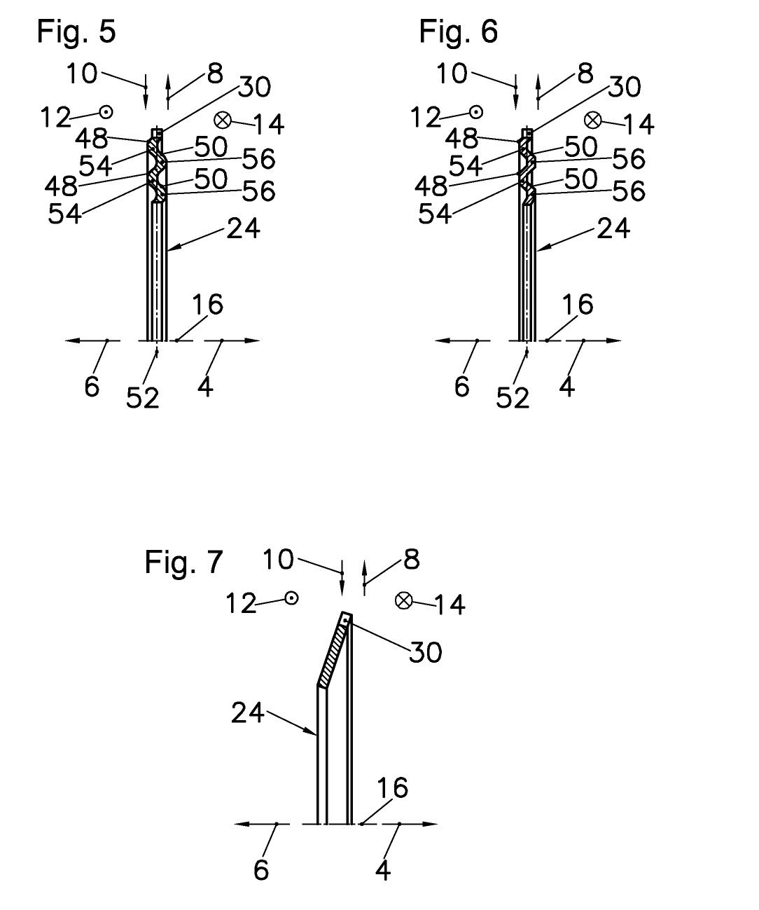

FIG. 5 shows a side view of an individual plate according to the invention in a fourth embodiment for use in the plate pack of FIG. 1, in a sectioned illustration,

FIG. 6 shows a side view of an individual plate according to the invention in a fifth embodiment for use in the plate pack of FIG. 1, in a sectioned illustration, and

FIG. 7 shows a side view of an individual plate according to the invention in a sixth embodiment for use in the plate pack of FIG. 1, in a sectioned illustration.

FIG. 1 shows an embodiment of the frictionally acting device according to the invention, which is designed in the present example as a multiplate clutch 2. More precisely, the multiplate clutch 2 of the illustrated embodiment is designed as a hydraulically actuable multiple plate clutch which has a first clutch and a second clutch, with FIG. 1 illustrating only the first clutch, which functions as a starting clutch of the hydraulically actuable multiple plate clutch. The first clutch and the second clutch can be selectively hydraulically actuated. Within the drivetrain (not illustrated in any more detail) of a motor vehicle, the multiplate clutch 2 is arranged between a drive unit, such as for example an internal combustion engine, and a transmission unit, such as for example an automatic transmission, in order to transmit the torque from the drive unit to the transmission unit. As already mentioned above, the first clutch, shown in FIG. 1, of the multiplate clutch 2 serves as a starting clutch. In FIG. 1, the opposite axial directions 4, 6, the opposite radial directions 8, 10 and the opposite circumferential directions 12, 14 of the multiplate clutch 2 are indicated by means of corresponding arrows, with the reference symbol 16 denoting the rotational axis of the multiplate clutch 2.

The multiplate clutch 2 has a first plate carrier 18 in the form of an outer plate carrier and a second plate carrier (20) in the form of an inner plate carrier. Assigned to the two plate carriers 18, 20 is a plate pack 22 which comprises a first plate set composed of steel plates 24, 26 which are designed as outer plates, and a second plate set composed of friction lining plates 28, with the friction lining plates 28 being designed as inner plates. Both the steel plates 24, 26 and also the friction lining plates 28 are of substantially annular-ring-shaped design, with the steel plates 24, 26 in each case having an outer toothing 30 and the friction lining plates 28 in each case having an inner toothing 32.

The outer toothings 30 of the steel plates 24, 26 of the first plate set engage into an inner toothing 34 on the first plate carrier 18, such that the steel plates 24, 26 are rotationally fixedly connected to the first plate carrier 18 in a positively locking fashion, with the steel plates 24, 26 also being arranged on the first plate carrier 18 so as to be movable in the axial direction 4, 6. In contrast, the inner toothings 32 of the friction lining plates 28 of the second plate set engage into an outer toothing 36 on the second plate carrier 20, such that the friction lining plates 28 are rotationally fixedly connected in a positively locking manner to the second plate carrier 20, with the friction lining plates 28 also being arranged on the second plate carrier 20 so as to additionally be movable in the axial direction 4, 6.

The steel plates 24, 26 are arranged alternately in series with the friction lining plates 28 of the second plate set in the axial direction 4, 6. In other words, the friction lining plates 28 engage in the manner of a comb into the intermediate spaces between the steel plates 24, 26. In the axial direction 4 and in the axial direction 6, the steel plates 24, 26 form in each case the end plate of the first plate set and of the plate pack 22. To generate a transmission of torque between the first plate carrier and the second plate carrier 18, 20, the plate pack 22 can be compressed in the axial direction 4, 6, such that the steel plates 24, 26 of the first plate set are placed in direct frictional engagement with the friction lining plates 28 of the second plate set. A frictionally engaging transmission of torque therefore takes place when the plate pack 22 is compressed.

To enable a compression of the plate pack 22, provision is made firstly of a hydraulically actuable actuating element 38 and secondly of a stop element 40. The actuating element 38, which may for example be a hydraulically driven actuating piston which is movable in the axial direction 4, 6, adjoins the end plate, which is situated at the end in the axial direction 6, in the form of the steel plate 26 of the first plate set, such that the plate pack 22 can be or is supported in the axial direction 6 on the actuating element 38 via the steel plate 26. In contrast, the stop element 40, which is arranged in the present example on the first plate carrier 18, adjoins the end plate, which is situated at the end in the axial direction 4, of the plate pack 22 in the form of the steel plate 26 of the first plate set, such that the plate pack 22 is or can be supported in the axial direction 4 on the stop element 40 via the end plate in the form of the steel plate 26.

The first plate set comprises a total number n of steel plates 24, 26, with n−2 steel plates, specifically the steel plates 24, being designed as plates of the type according to the invention, while two steel plates of the first plate set, specifically the steel plates 26 which function as end plates, are designed as conventional steel plates which are of flat or planar design and therefore do not have any elastic deformability or resilience in the axial direction 4, 6. The differences between the steel plates 24 according to the invention and the conventional steel plates 26 will be discussed in greater detail further below. Firstly, however, it is intended to describe the difference between the steel plates 24, 26 of the first plate set on the one hand and the friction lining plates 28 of the second plate set on the other hand. In contrast to the steel plates 24, 26, the friction lining plates 28 are composed in each case of a friction lining carrier 42 and two friction linings 44, 46, with the friction linings 44, 46 being attached to the opposite sides, which point in the axial directions 4 and 6 respectively, of the friction lining carrier 42 in order to form the friction surfaces of the friction lining plate 28. In contrast, the steel plates 24, 26 duly also have friction surfaces which point in the axial directions 4, 6, but said friction surfaces are formed by the steel plates 24, 26 themselves, without an additional friction lining being provided on the steel plates 24, 26.

The abovementioned steel plates 24 according to the invention of the first plate set have, independently of the embodiments described further below with reference to FIGS. 2 to 7, the property that said steel plates 24 are designed so as to be elastically deformable or resilient in the axial direction 4, 6. In contrast to the conventional plates known from DE 102 55 537 B4 in connection with an undulating disk, this has the advantage that any axial run-out which may be present can be compensated directly at the point at which it occurs, with the axial structural length of the plate pack 22 and therefore the axial structural length of the multiplate clutch 2 also being reduced. Furthermore, the advantage is obtained that the weight of the plate pack 22 is reduced, especially because it is possible to dispense with an additional undulating disk which does not function as a friction partner. Here, the elastic deformability or resilience of the steel plates 24 can be obtained in different ways, which will be described below with reference to FIGS. 2 to 7.

FIG. 2 thus shows a side view of the plate pack 22 with a first embodiment of the steel plates 24. As can be seen from FIG. 2, in contrast to the steel plates 26 and the friction lining plates 28, the steel plates 24 have an undulating profile in the circumferential direction 12, 14, with the steel plates 24 in the illustrated embodiment having a sinusoidal profile in the circumferential direction 12, 14. In this way, the steel plates 24 are also designed so as to be elastically deformable or resilient in the circumferential direction 12, 14.

On account of the undulating profile of the steel plates 24 in the circumferential direction 12, 14, the steel plates 24 have a multiplicity of wave peaks 48 which project in the axial direction 6, and a corresponding number of wave troughs 50 which project in the axial direction 4. Here, the term “wave peak” 48 denotes that section of the steel plate 24 which projects in the axial direction 6 beyond an imaginary central plane 52 of the steel plate 24, with the normal to the central plane 52 extending in the axial direction 4, 6. In contrast, those sections of the steel plate 24 which project in the axial direction 4 beyond the imaginary central plane 52 are referred to as wave troughs 50.

In the case of a steel plate 24 with an undulating profile in the circumferential direction 12, 14, at least three of said wave peaks 48 and a corresponding number of wave troughs 50 should be provided, with in particular four to six wave peaks and a corresponding number of wave troughs having been proven to be advantageous, especially since the axial structural length of the plate pack 22 can be reduced in this way. This is to be attributed to the fact that, with a higher number of wave peaks and troughs, a smaller wave height is required. In this respect, it has proven to be particularly advantageous for the steel plate 24 to have more than six wave peaks and a corresponding number of wave troughs 50. In FIG. 1, the central points of the wave peaks 48 are denoted by the reference sign 54. The central points 54 are preferably the closest points, or the peak tips of the wave peaks 48, which are at the greatest distance in the axial direction 6 from the imaginary central plane 52. Correspondingly, the central points of the wave troughs 50 are denoted by the reference symbol 56. Here, too, the central points 56 of the wave troughs 50 are preferably those points of the wave troughs 50 which are at the greatest distance in the axial direction 4 from the imaginary central plane 52 of the respective steel plate 24.

As can be seen from FIG. 2, all the steel plates 24 of the first plate set are connected, in a rotationally fixed manner relative to one another, to the first plate carrier 18 in such a way that the wave peaks 48 of said steel plates 24 are arranged in alignment with one another in the axial direction 4, 6. Here, at least more than 50%, preferably more than 75% of the width of a wave peak 48 in the circumferential direction 12, 14 should be arranged in alignment in the axial direction 4, 6 with the wave peak 48 of an adjacent steel plate 24, that is to say of a steel plate 24 which follows directly in the axial direction 4 or 6, in order to obtain a particularly high degree of torque uniformity of the multiplate clutch 2 during the transmission of torque and in order to be able to reliably compensate any axial run-out or tolerances which may be present. However, in order to obtain optimum torque uniformity of the multiplate clutch 2 and an optimum compensation of any axial run-out or tolerances which may be present, it is preferable if the central points 54 of the wave peaks 48 of the steel plates 24 are arranged in alignment with one another in the axial direction 4, 6, as indicated in FIG. 2 by means of the auxiliary lines 58. On account of the uniform profile of the steel plates 24 in the circumferential direction 12, 14, the central points 56 of the wave troughs 50 are also arranged in alignment with one another in the axial direction 4, 6, as indicated by means of the auxiliary lines 60. Should a precisely aligned arrangement of the central points 54, 56 not be possible on account of the toothings 30, 34, then it should at least be ensured that the central points 54, 56, which are assigned to one another, of the adjacent steel plates 24 are arranged as close as possible to one another in the circumferential direction 12, 14.

A second embodiment of the steel plates 24 is described below with reference to FIG. 3, which second embodiment corresponds substantially to the embodiment according to FIG. 2, such that only the differences are discussed below, the same reference symbols are used for identical or similar parts, and the above description in this regard applies correspondingly.

In contrast to the first embodiment according to FIG. 2, the steel plates 24 of the second embodiment have a stepped profile in the circumferential direction 12, 14. For this reason, in the second embodiment, reference is also made to step peaks 48 and step troughs 50. In the case of a stepped profile of the steel plates 24 in the circumferential direction 12, 14, it is possible to create greater friction surfaces about the central point 54 of the step peaks 48 or the central point 56 of the step troughs 50 than is possible with the continuously oscillating profile of the steel plates 24 according to FIG. 2. It should however be noted that a stepped profile may of course also be an undulating profile.

A third embodiment of the steel plates 24 within the plate pack 22 is described below, which third embodiment corresponds substantially to the embodiments according to FIGS. 2 and 3, such that only the differences are discussed below, identical reference symbols are used for identical or similar parts, and the preceding description in this regard applies correspondingly.

While the steel plates 24 in the first and second embodiments have an undulating or stepped profile overall in the circumferential direction 12, 14, only partial regions of the steel plates 24 are designed so as to be elastically deformable or resilient in the axial direction 4, 6 in the steel plates 24 of the third embodiment. For this purpose, individual regions of the steel plate 24 are provided with axially projecting spring tongues or bridges 62, 64 which are preferably formed in one piece with the steel plate 24. The spring tongues or bridges 62, 64 may thus for example have been generated by partially punching out or embossing the steel plate 24. The spring tongues or bridges 62 thus project in the axial direction 6 beyond the imaginary central plane 52 of the respective steel plate 24, while the spring tongues or bridges 64 project in the axial direction 4 beyond the central plane 52 of the respective steel plate 24. The spring tongues or bridges 62, 64 may again have the undulating or stepped profile already mentioned above. The central points 54 of the steel plates 24, which are adjacent to one another, should again be arranged in alignment with one another in the axial direction 4, 6, as already described above.

FIG. 5 shows a fourth embodiment of the steel plate 24 for use in the multiplate clutch 2 according to FIG. 1 on its own, with the fourth embodiment of the steel plate 24 according to FIG. 5 corresponding substantially to the embodiments of the steel plates 24 according to FIGS. 2 to 4, such that only the differences are discussed below, identical reference symbols are used for identical or similar parts, and the preceding description otherwise applies correspondingly.

In contrast to the steel plates 24 according to FIGS. 2 to 4, the steel plate 24 in the fourth embodiment according to FIG. 5 has an undulating profile in the radial direction 8, 10. It is preferable in this embodiment too for the steel plate 24 to have a sinusoidal profile in the radial direction 8, 10, as shown in FIG. 5. On account of the undulating profile in the radial direction 8, 10, the steel plate 24 is also designed so as to be elastically deformable or resilient in the radial direction 8, 10. Since only a small amount of material which can be shaped to form an undulating profile is available in the radial direction 8, 10 of the steel plate 24, a relatively small number of wave peaks and wave troughs can be provided in this embodiment of the steel plate 24. It has however proven to be advantageous if the steel plate 24 in the fourth embodiment has at least two wave peaks 48. Here, it is fundamentally sufficient for said two wave peaks 48 to be assigned only one wave trough 50. It has however proven to be particularly advantageous for the same number of wave troughs 50 to be provided, as shown in FIG. 5.

A fifth embodiment of the steel plate 24 for use in the multiplate clutch 2 according to FIG. 1 is described below with reference to FIG. 6, with the fifth embodiment being substantially the same as the fourth embodiment according to FIG. 5, such that only the differences are discussed below, identical reference symbols are used for identical or similar parts, and the preceding description of the fourth embodiment in this regard applies correspondingly.

The steel plate 24 in the fifth embodiment according to FIG. 6 also has an undulating profile in the radial direction 8, 10, with the undulating profile being formed here as a stepped profile. The wave peaks are therefore again referred to as step peaks 48, whereas the wave troughs are again referred to as step troughs 50. The preceding description of the embodiments according to FIGS. 2 to 5 otherwise applies correspondingly.

FIG. 7 shows a sixth embodiment of the steel plate 24, which is substantially similar to the embodiments described above, such that only the differences are discussed below, identical reference symbols are used for identical or similar parts, and the preceding description in this regard applies correspondingly.

The steel plate 24 in the sixth embodiment according to FIG. 7 is of conical design in the axial direction 4, 6. In other words, therefore, the steel plate 24 is formed in the manner of a plate spring. As a result of the conical design of the steel plate 24 in the axial direction 4, 6, said steel plate is also designed so as to be elastically deformable or resilient in the radial direction 8, 10. An increase in the torque uniformity of the multiplate clutch 2 can be obtained by means of the steel plate 24 in the sixth embodiment too, although the more optimum solution is to be found in the embodiments according to FIGS. 2 to 6.

The above-described embodiments of the steel plate 24 and of the undulating or stepped profiles thereof can be produced by means of cold or hot working of the steel plates 24. Here, however, it is preferable for the undulating or stepped profiles to be produced by means of cold working of the steel plates 24, especially since more precise or more predictable shaping is possible in this way. In contrast, the dimensions of an undulating or stepped profile of the steel plate 24 produced by means of hot working may still change during cooling, such that a targeted coordination of the dimensions of the steel plates 24 to the intended task within the multiplate clutch 2 is not possible to the same extent. From a production aspect, it has also proven to be advantageous for the steel plate 24 to be punched out of a sheet-metal part, with the cold working of the steel plate 24 to produce the undulating or stepped profile taking place already during the punching-out process.

In the above-described embodiments according to FIGS. 1 to 7, only the steel plates 24 have been designed in the manner according to the invention, while the friction lining plates 28 were conventional friction plates 28 of flat or planar design. In an alternative embodiment, however, the friction lining plates 28 may also be designed in the manner according to the invention, while the steel plates 24 may likewise be designed in the manner of the conventional steel plates 26. To obtain the desired advantages, the friction lining carrier 42 or the friction lining 44, 46 is then designed so as to be elastically deformable or resilient in the axial direction 4, 6, in the circumferential direction 12, 14 and/or in the radial direction 8, 10. In this case, the friction lining carrier 42 or the friction lining 44, 46 may preferably have an undulating, preferably sinusoidal or stepped profile in the circumferential direction 12, 14 and/or in the radial direction 8, 10. It is also possible for the friction lining carrier 42 or the friction lining 44, 46 to be of conical design in the axial direction 4, 6. With regard to said design variants of the friction lining plates 28 according to the invention, reference is made here to the preceding description of the design variants of the steel plates 24 according to the invention, which applies correspondingly.

Since friction lining plates 28 generally have a lower degree of stiffness than the above-described steel plates 24, 26, the friction lining plates 28 with an undulating or stepped profile in the circumferential direction and/or in the radial direction should then have at least two or six, preferably eight to twelve, particularly preferably more than twelve wave or step peaks, and particularly preferably the same number of wave or step troughs. In the case of a friction lining plate 28 with an undulating or stepped profile in the radial direction 8, 10, therefore, it is advantageous to provide even two wave or step peaks, while in the case of a friction lining plate 28 with an undulating or stepped profile in the circumferential direction 12, 14, it is advantageous to provide the above-mentioned at least six, preferably eight to twelve, particularly preferably more than twelve wave or step peaks.

At this juncture, it should additionally be pointed out that it is likewise possible to create a multiplate clutch 2 in which both individual steel plates 24 and also individual friction lining plates 28 are designed in the manner according to the invention. In said case, however, it should be ensured that the individual steel plates 24 according to the invention do not directly adjoin an individual friction lining plate 28 according to the invention in terms of frictional engagement if the steel plates 24 and friction lining plates 28 have an undulating or stepped profile in the circumferential direction 12, 14.

### LIST OF REFERENCE SYMBOLS

2 Multiplate clutch
4 Axial direction
6 Axial direction
8 Radial direction
10 Radial direction
12 Circumferential direction
14 Circumferential direction
16 Rotational axis
18 First plate carrier
20 Second plate carrier
22 Plate pack
24 Steel plates
26 Steel plates
28 Friction lining plates
30 Outer toothing
32 Inner toothing
34 Inner toothing
36 Outer toothing
38 Actuating element
40 Stop element
42 Friction lining carrier
44 Friction lining
46 Friction lining
48 Wave peaks/Step peaks
50 Wave troughs/Step troughs
52 Central plane
54 Central points
56 Central points
58 Auxiliary line
60 Auxiliary line
62 Spring tongue/bridge
64 Spring tongue/bridge

1. A plate for a frictionally acting device, which plate can be rotationally fixedly connected, in a positively locking manner, to a plate carrier, wherein the plate is designed so as to be elastically deformable in a axial direction.

2. The plate as claimed in claim 1, wherein the plate is also designed to be elastically deformable in a circumferential direction and in a radial direction.

3. The plate as claimed in claim 1, wherein the plate is of annular-disk-shaped design and has an outer or inner toothing for rotationally fixed connection to the plate carrier.

4. The plate as claimed in claim 1, wherein the plate has an undulating or stepped profile in a circumferential direction and in a radial direction, with the plate having a sinusoidal profile in the circumferential direction and in the radial direction.

5. The plate as claimed in claim 1, wherein the plate has at least one axially projecting spring tongue which can be pressed against a counterpart plate, with at least three axially projecting spring tongues being provided.

6. The plate as claimed in claim 1, wherein the plate is of conical design in the axial direction.

7. The plate as claimed in claim 1, wherein the plate is formed as a steel plate.

8. The plate as claimed in claim 1, wherein the plate is designed as a friction lining plate which has a friction lining carrier and at least one friction lining which is arranged on the friction lining carrier, wherein at least one of the friction lining carrier and the friction lining is formed so as to be elastically deformable in the axial direction, in a circumferential direction and in a radial direction, has one of an undulating, sinusoidal, and stepped profile in the circumferential direction and in a radial direction, and is of conical design in the axial direction.

9. The plate as claimed in claim 7, wherein the plate which is formed as a steel plate has at least two wave peaks and the same number of wave troughs, or in that the plate which is formed as a friction lining plate has at least two or wave peaks and the same number of wave troughs.

10. The plate as claimed in claim 4, wherein the undulating profile of the plate is produced by means of one of cold and hot working, as the plate is punched out from a sheet-metal part.

11. A frictionally acting device, having a first plate set, which is rotationally fixedly connected to a first plate carrier, and having a second plate set which is rotationally fixedly connected to a second plate carrier and whose plates can be placed, in frictional engagement with the plates of the first plate set in an axial direction, wherein at least one plate of the first and second plate set is a plate as claimed in claim 1.

12. The frictionally acting device as claimed in claim 11, wherein one of the first or second plate sets has n plates, with at least n−2 plates being designed as plates as claimed in one of claim 1, with two conventional plates forming the end plates of said plate set, and wherein at least one of the conventional plates is or can be supported in the axial direction on one of an actuating element and stop element for said plate set.

13. The frictionally acting device as claimed in claim 11, wherein at least two, of the plates, which are adjacent to one another in the axial direction, of the first and second plate set are connected, in a rotationally fixed manner relative to one another, to the corresponding plate carrier in such a way that the wave peaks, of the one plate are arranged substantially in alignment in the axial direction with the wave or step peaks of the adjacent plate, the one plate being arranged substantially in alignment in the axial direction with the wave troughs of the adjacent plate.

14. The frictionally acting device as claimed in claim 11, wherein at least two, of the plates, which are adjacent to one another in the axial direction, of the first and second plate sets are connected, in a rotationally fixed manner relative to one another, to the corresponding plate carrier in such a way that the central points, of the wave peaks of the one plate are arranged substantially in alignment in the axial direction with the central points of the wave peaks of the adjacent plate, the wave troughs of the one plate being arranged substantially in alignment in the axial direction with the central points of the wave peaks of the adjacent plate.

15. The frictionally acting device as claimed in claim 11, wherein the frictionally acting device, which is designed as a multiple plate clutch, has at least one first clutch, which functions as a starting clutch, and a second clutch, with at least one plate of the first clutch being a plate as claimed in claim 1.
